(19) United States
(12) Patent Application Publication
(10) Pub. No.: US 2006/0039073 A1
(43) Pub. Date: Feb. 23, 2006

(54) Prism sheet of liquid crystal display and back light unit using the same

(76) Inventors: Sang Gon Lee, Daegu-si (KR); Chang Jong Kim, Cheongju-si (KR); Young Gun Kim, Cheongju-si (KR); Yun Ho Choi, Seoul (KR); Ho Sung Chin, Seoul (KR); Boug Taek Hong, Cheongju-si (KR); Kab Jin Hwang, Cheongju-si (KR); Ung Sang Lee, Cheongju-si (KR); Chul Young Kim, Seoul (KR)

Correspondence Address: MCKENNA LONG & ALDRIDGE LLP, 1900 K STREET, NW, WASHINGTON, DC, 20006, US

(21) Appl. No.: 11/024,808

(22) Filed: Dec. 30, 2004

(30) Foreign Application Priority Data
Aug. 23, 2004 (KR) 2004-66502

(51) Int. Cl. G02F 1/1347; G02B 5/02; G02B 13/20; G02B 5/04

(52) U.S. Cl. 359/599; 359/831

(57) ABSTRACT

A prism sheet of a liquid crystal display (LCD) includes a body part made of a transparent resin material; and a plurality of intaglio-type optical unit structures arranged on the body part, each of the optical unit structures having an intaglio-type or a relief type polyhedron inside of a rectangular structure thereof, a center of the intaglio portion forming a line, not a dot.

This application claims the benefit of Korean Patent Application No. 2004-66502, filed in Korea on Aug. 23, 2004, which is hereby incorporated by reference for all purposes as if fully set forth herein.

### BACKGROUND OF THE INVENTION

1. Field of the Invention

The present invention relates to a non-luminous flat display device, and more particularly, to an optical sheet of a backlight unit in a liquid crystal display.

2. Description of the Related Art

Recently, a variety of flat panel displays have been developed to reduce the weight and volume of the displays, which are drawbacks of cathode ray tubes (CRTs).

Such flat panel displays include a liquid crystal display (LCD), a field emission display, a plasma display panel (PDP), an electro-luminescence (EL) and the like. Research for enhancing the display quality and increasing the screen size of the flat panel displays is being actively performed.

Among such flat panel displays, the LCD itself is a non-luminous device, which displays images using a light source such as a lamp, and has advantages of small size, lightweight, low power consumption characteristics. In particular, the LCD displays information using electrical and optical properties of liquid crystal molecules interposed in an inside of a liquid crystal display.

In other words, unlike the CRT, in the LCD, since the liquid crystal molecules interposed between a thin film transistor (TFT) substrate and a color filter substrate do not emit light on their own, the LCD essentially needs a separate unit for irradiating light, i.e., a backlight unit.

The backlight unit includes: a mold frame having a receiving space; a reflector mounted on the lowest surface of the receiving space, for reflecting light toward a liquid crystal display panel; a light guide plate disposed on the reflector, for guiding light; a lamp unit disposed between the light guide plate and a sidewall of the receiving space, for emitting light; optical sheets stacked on the light guide plate, for diffusing and concentrating light; and a top chassis disposed on the mold frame, for enclosing the liquid crystal display from a predetermined portion of the edge of the liquid crystal display to a side portion of the mold frame.

The optical sheets include: a diffusion sheet for diffusing light; a prism sheet disposed on the diffusion sheet, for concentrating the diffused light and transferring the concentrated light to the liquid crystal display; and a protection sheet for protecting the diffusion sheet and the prism sheet.

FIG. 1 is a cross-sectional view of a related art LCD.

Referring to FIG. 1, the related art LCD 60 includes: a backlight unit 50 for generating light; and a display unit 40, which receives the light from the backlight unit 50 and displays images.

The backlight unit 50 includes a lamp unit 51 for generating light and a light guide unit for guiding the light generated by the lamp unit 51 toward the liquid crystal display 10.

The display unit 40 includes the liquid crystal display panel 10 and an upper polarizer 30 and a lower polarizer 20 respectively disposed on an upper surface and a lower surface of the liquid crystal display panel 10. The liquid crystal display panel 10 includes a TFT substrate 11; a color filter substrate 12 each having electrodes formed thereon; and a liquid crystal layer interposed between the TFT substrate 11 and the color filter substrate 12.

More specifically, the lamp unit 51 includes a lamp 51a for generating light and a lamp reflector 51b enclosing the lamp 51a. The light generated by the lamp 51a is provided into a light guide plate 52, which will be described later. The lamp reflector 51b reflects the light generated by the lamp 51a toward the light guide plate 52, thereby increasing amount of light provided to the light guide plate 52.

The light guide unit includes a reflection plate 54, the light guide plate 52, and optical sheets 53. The light guide plate 52 is disposed at one end of the lamp unit 51 to guide the light emitted from the lamp unit 51 so that the light emitted from the lamp unit 51 is incident into the LCD panel 10.

The reflection plate 54 is disposed beneath the light guide plate 52 and reflects light leaked from the light guide plate 52 toward the light guide plate 52 again.

The plurality of optical sheets 53 are disposed on the light guide plate 52 to enhance efficiency of the light passing through the light guide plate 52. Specifically, the optical sheets 53 include a diffusion sheet 53a, a prism sheet 53b, and a protection sheet 53c, and are sequentially stacked on the light guide plate 52.

The diffusion sheet 53a scatters the light that is incident from the light guide plate 52, thereby making the brightness distribution of the light uniform. The prism sheet 53b has a plurality of prisms repeatedly formed on its upper surface, and concentrates the light diffused by the diffusion sheet 53a in a direction perpendicular to a plane of the LCD panel 10. Accordingly, the light that has passed through the prism sheet 53b mostly progresses in a direction perpendicular to the plane of the LCD panel 10, so that a uniform brightness distribution is obtained.

The protection sheet 53c provided on the prism sheet 53b functions not only to protect the upper surface of the prism sheet 53b, but also to diffuse light so as to make uniform the distribution of the light that is incident from the prism sheet 53b.

FIGS. 2A and 2B are a cross-sectional view and a perspective view of the prism sheet illustrated in FIG. 1, respectively.

Referring to FIGS. 2A and 2B, the related art prism sheet 200 includes a body part 210 through which the light diffused by the light guide plate and the diffusion sheet is initially introduced, and a protrusion part 220 shaped in a isosceles triangle prism having a predetermined vertical angle α, for maintaining a path of the diffused light constantly. The protrusion part 220 has a plurality of isosceles triangle prisms linearly arranged on the body part 210 in a stripe form.

In case the protrusion part 220 of a triangle prism shape is installed toward a front side, namely, the protrusion part becomes a light outputting surface and faces the liquid crystal display panel, diffused light introduced from the body part 210 is refracted and concentrated to a front side, but light incident into an incline plane of the protrusion part is lost, not contributing to improvement of a front brightness due to a total internal reflection.

To overcome such a problem, the prism sheet may be conversely arranged so that the protrusion part 220 becomes a light receiving surface and faces the light guide plate. However, in that case, a front brightness can be improved but a viewing angle becomes narrow, which is not suitable for a flat display requiring a wide viewing angle such as a television for a home use.

Further, two prism sheets may be overlapped and used in such a way that arrangement directions of the protrusion parts thereof are crossed. However, such an arrangement increases a number of parts used in the LCD and increases manufacturing costs.

### SUMMARY OF THE INVENTION

Accordingly, the present invention is directed to a prism sheet of an LCD (liquid crystal display) and a back light unit using the same that substantially obviate one or more problems due to limitations and disadvantages of the related art.

An advantage of the present invention is to provide a prism sheet of an LCD and a back light unit using the same, capable of enhancing a light-concentrating effect and a viewing angle characteristics by arranging a plurality of intaglio-type optical unit structures on one side of the prism and configuring in such a way that the intaglio-type optical unit structures constitute a polyhedron.

To achieve these and other advantages and in accordance with the purpose of the invention, as embodied and broadly described herein, a prism sheet of an LCD includes: a body part made of a transparent resin material; and a plurality of intaglio-type optical unit structures arranged on the body part, each of the optical unit structures having an intaglio-type polyhedron in an inside of a rectangular structure thereof, a center of the intaglio portion forming a line, not a dot.

In another aspect of the present invention, a prism sheet of an LCD includes: a body part made of a transparent resin material; and a plurality of relief-type optical unit structures arranged on the body part, each of the optical unit structures having a relief-type polyhedron in an outside of a rectangular structure thereof, a center of the relief portion forming a line, not a dot.

According to still another aspect of the present invention, a back light unit of an LCD includes: a lamp for generating light; a light guide plate arranged in one end of the lamp, for guiding the light; a reflection plate arranged on a lower part of the light guide plate, for preventing the light emitted from the lamp, from leaking out; a diffusion sheet and a prism sheet arranged on an upper part of the light guide plate, for improving efficiency of the light emitted from the light guide plate, the prism sheet having a body part made of a transparent resin material and a plurality of intaglio-type optical unit structures arranged on the body part, each of the optical unit structures having an intaglio-type polyhedron in an inside of a rectangular structure thereof, a center of the intaglio portion forming a line, not a dot.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a cross-sectional view illustrating a construction of a related art LCD;

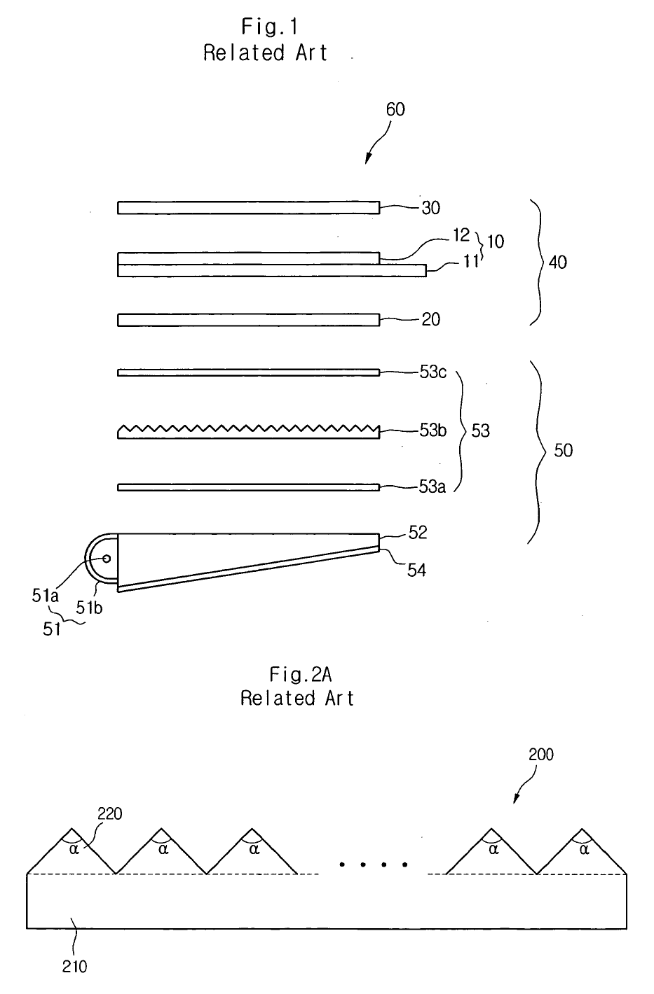

FIGS. 2A and 2B are a cross-sectional view and a perspective view of the prism sheet illustrated in FIG. 1, respectively;

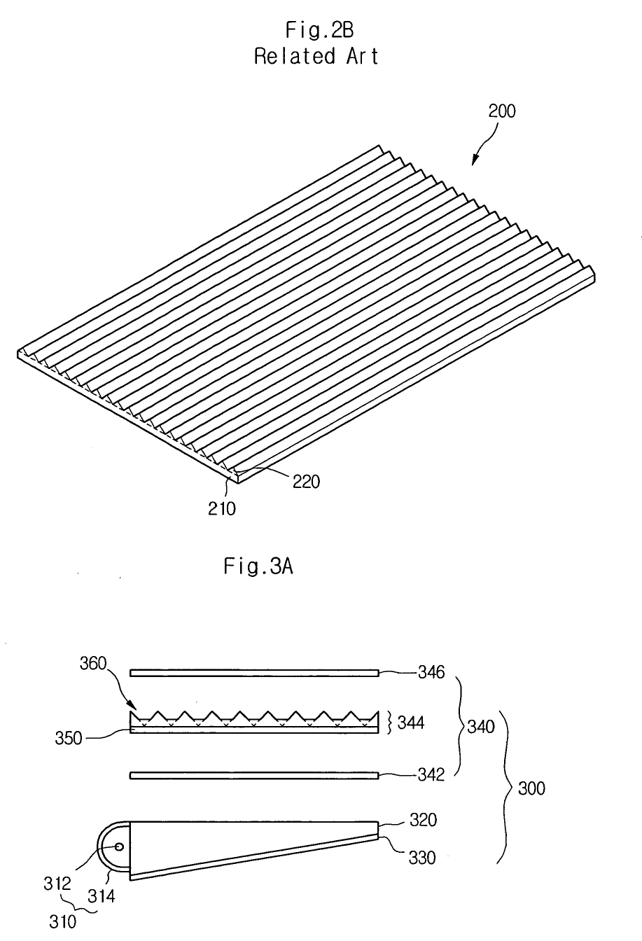

FIGS. 3A and 3B are cross-sectional views illustrating a construction of a backlight unit of an LCD according to the present invention;

FIGS. 4A and 4B are a cross-sectional view and a perspective view illustrating a prism sheet of an LCD according to the present invention;

FIGS. 5A and 5B are a plan view and a perspective view illustrating an optical unit structure of the prism sheet illustrated in FIG. 4;

FIG. 6 is a graph illustrating relation between a viewing angle of the prism sheet according to the present invention and a length D of a central line of the optical unit structure explained with reference to FIG. 5;

FIG. 7 is a graph illustrating relation between an angle b formed by a horizontal plane and a plurality of polyhedrons in the optical unit structure explained with reference to FIGS. 4 and 5 and a light-concentration degree of the prism sheet according to the present invention; and

FIG. 8A is a perspective view of a prism sheet according to another embodiment of the present invention. FIG. 8B is a cross-sectional view of the embodiment illustrated in FIG. 8A.

### DETAILED DESCRIPTION OF THE INVENTION

Reference will now be made in detail to embodiments of the present invention, examples of which are illustrated in the accompanying drawings.

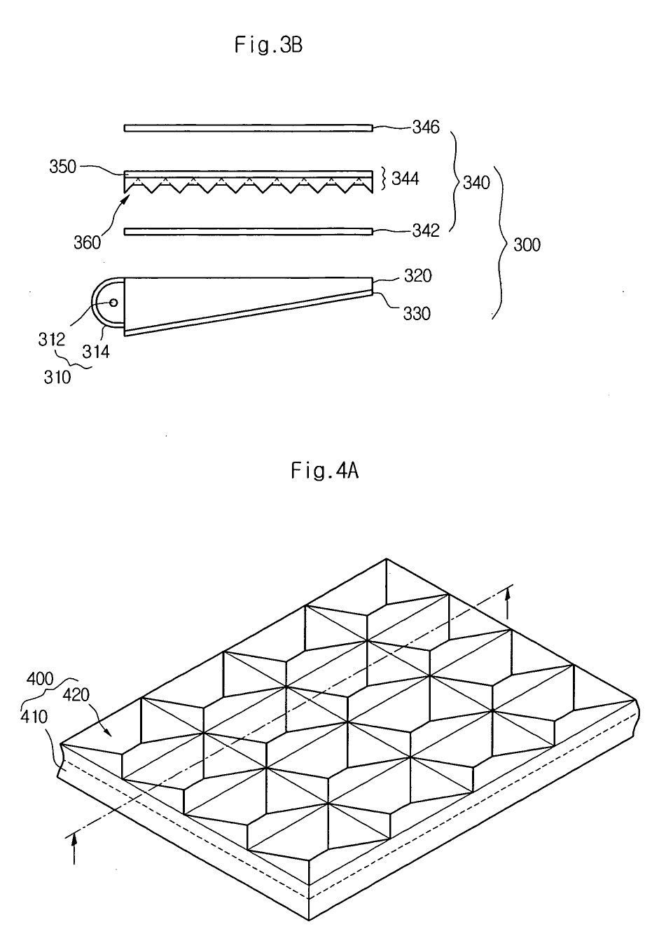

FIGS. 3A and 3B are cross-sectional views illustrating a construction of a backlight unit of an LCD according to the present invention.

Referring to FIGS. 3A and 3B, a backlight unit 300 according to the present invention includes: a lamp unit 310 for generating light; and a light guide unit for guiding the light from the lamp unit 310 toward a liquid crystal display panel.

Here, the light guide unit has a plurality of optical sheets 340. Among those optical sheets 340, a prism sheet is configured in such a way that a plurality of intaglio-type optical unit structures made of PMMA (Polymethylmethacrylate) is arranged on a body part made of a transparent resin material such as PET (polyethyleneterephthalate) or PC (Polycarbonate). In such intaglio-type optical unit structures, a center portion is depressed relative to an edge portion of a polyhedron.

At this point, the plurality of optical unit structures arranged on the prism sheet is configured such that an intaglio-type polyhedron is formed in an inside of the rectangular structure and a center of the intaglio portion forms a line, not a dot.

Here, it is possible to obtain a proper light-concentrating degree and an improved viewing angle thanks to a prism sheet of the present invention by adjusting the center of the intaglio, i.e., a length D of a line formed at the center of the intaglio portion.

In the related art prism sheet, when a viewing angle to either up/down, or left/right direction is improved, a viewing angle characteristics for the other direction is inevitably deteriorated. However, when the prism sheet of the present invention is adopted, a viewing angle characteristics for up/down and left/right directions can be improved through a plurality of polyhedrons constituting the optical unit structures.

Further, it is possible to minimize brightness deterioration due to an enlargement of the viewing angle by maintaining constant an angle formed by the plurality of polyhedrons constituting the optical unit structures and a horizontal plane. At this point, the angle formed by an incline plane of each polyhedron and a horizontal plane may be determined within a range of about 30-60°.

The transparent resin material constituting the body part may have a transmittance of more than about 70%. The transparent resin material can be formed on one side of the body part, i.e., a surface opposite to the surface where the optical unit structures are formed, by embossing small-sized protuberances as structures for diffusing light or by providing grains made of PMMA, which is a material for diffusing light into an inside of the body part.

Further, the lamp unit 310 includes: a lamp 312 for generating light; and a lamp reflector 314 enclosing the lamp 312. Light emitted from the lamp 312 is incident into a light guide plate 312 and the lamp reflection plate 330 improves an amount of light incident to the light guide plate 320 by reflecting the light emitted from the lamp 312 toward the light guide plate 320, which are the same as the construction of the general lamp unit.

Here, the light guide unit includes the reflection plate 330; the light guide plate 320; and the optical sheets 340. The light guide plate 320 is provided to one side of the lamp unit 310 to guide the light emitted from the lamp unit 310. At this point, the light guide plate 320 changes a path of the light emitted from the lamp unit 310 to guide the light toward the liquid crystal display panel.

The reflection plate 330 is disposed beneath the light guide plate 320 and reflects light leaked from the light guide plate 320 back to the light guide plate 320.

The plurality of optical sheets 340 are disposed on the light guide plate 320 to enhance efficiency of the light that has passed through the light guide plate 320. Specifically, the optical sheets 340 include a diffusion sheet 342; a prism sheet 344; and a protection sheet 346. Those sheets are sequentially stacked on the light guide plate 320.

The diffusion sheet 342 scatters the light that is incident from the light guide plate 320, thereby making uniform the brightness distribution of the light.

Further, the above-described prism sheet 344 of the present invention may be arranged such that the plurality of intaglio-type optical unit structures is opposite to the diffusion sheet 342 as illustrated in FIG. 3A, or may be arranged such that the other surface on which the protrusion parts are not formed is opposite to the diffusion sheet 342 as illustrated in FIG. 3B.

However, in case small-sized protuberances as structures for diffusing light are embossed on a surface of the body part of the prism sheet, i.e., a surface opposite to the surface where the optical unit structures are formed, the diffusion sheet may be omitted.

Further, the protection sheet 346 provided on the prism sheet 344 diffuses the light in order to make uniform a distribution of the light incident from the prism sheet 346 as well as protects a surface of the prism sheet 344. The protection sheet 346 may be removed depending on cases.

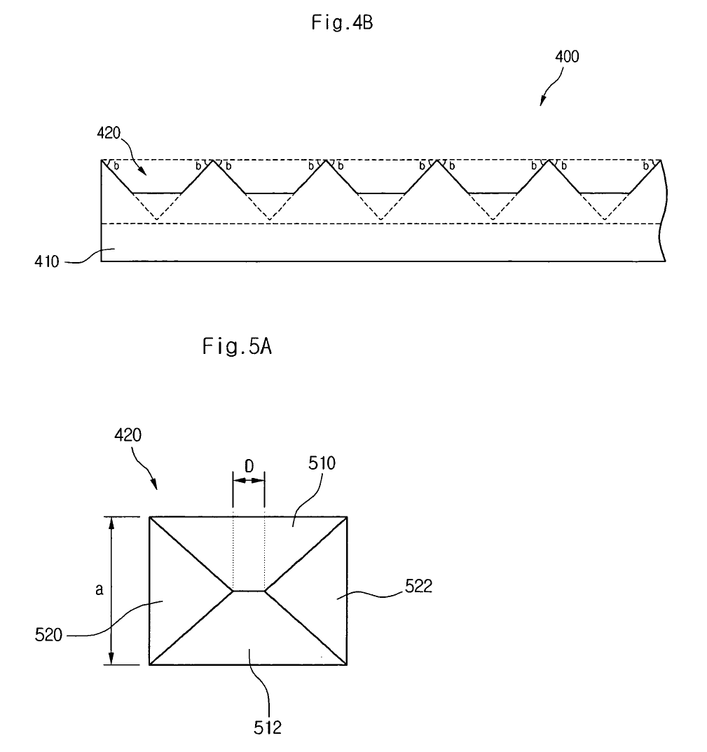

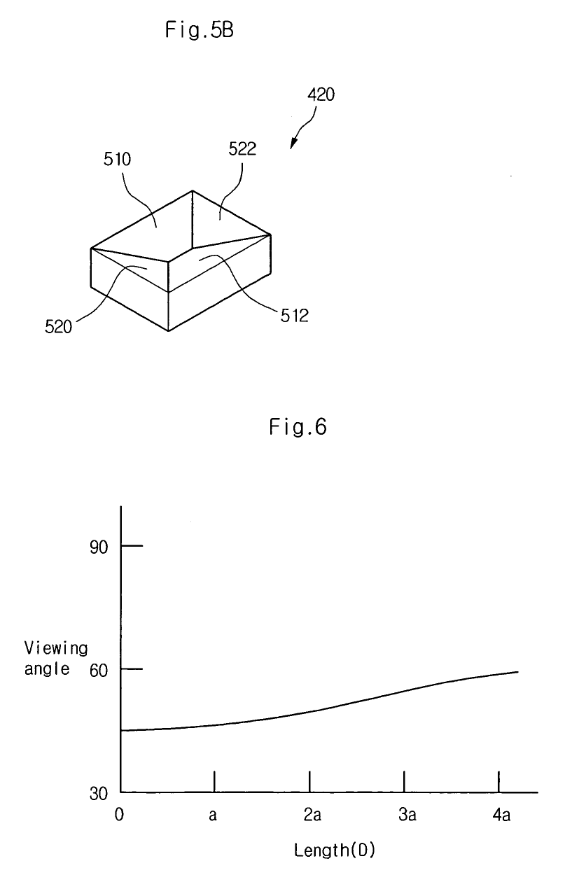

FIGS. 4A and 4B are a cross-sectional view and a perspective view illustrating a prism sheet of an LCD according to the present invention, and FIGS. 5A and 5B are a plan view and a perspective view illustrating an optical unit structure of the prism sheet illustrated in FIG. 4.

Here, the prism sheet explained with reference to FIG. 4 is the same as the prism sheet provided to the backlight unit explained earlier with reference to FIG. 3

As illustrated in FIG. 4A and FIG. 4B, the prism sheet according to the present invention is configured in such a way that a plurality of intaglio-type optical unit structures 420, which may be made of PMMA (polymethylmethacrylate), is arranged on a body part made of a transparent resin material such as PET (polyethyleneterephthalate) or PC (Polycarbonate).

Here, the transparent resin material constituting the body part may have a transmittance of more than 70%. The transparent resin material can be formed on one side of the body part 410, i.e., a surface opposite to the surface where the optical unit structures are formed, by embossing small-sized protuberances as structures for diffusing light or by providing grains made of PMMA, which is a material for diffusing light into an inside of the body part.

Further, the plurality of intaglio-type optical unit structures 420 formed on the body part 410 may be formed by making liquid PMMA material into an intaglio through a relief mold on the body part 410 and then hardening the liquid PMMA by an ultraviolet hardening method to be finally combined with the body part 410.

At this point, the plurality of optical unit structures arranged on the prism sheet is configured such that an intaglio-type polyhedron is formed in an inside of a rectangular structure and a center of the intaglio portion forms a line, not a dot.

For example, as illustrated in FIG. 5, an intaglio-type polyhedron formed in an inside of the rectangular structure whose vertical length is a, is configured such that a pair of trapezoids 510 and 512 and a pair of triangles 520 and 522 face each other, forming four planes.

At this point, since a pair of the trapezoids 510 and 512 meet each other, the optical unit structure 420 has a line-type intaglio center. That is, the D-length side of the trapezoids 510 and 512 is shared and is depressed with respect to the longer sides of the trapezoids 510 and 512. In addition, the vertices of the triangles 520 and 522 abut opposite ends of the D-length side of the trapezoids 510 and 512 and those vertices are depressed with respect to the A-length sides of the rectangle. The prism sheet of the present invention can obtain a proper light-concentrating degree and an improved viewing angle by adjusting the intaglio center, i.e., a length D of a line formed at the central portion of the intaglio.

Here, the length D of the line formed at the central portion of the intaglio may not exceed double the vertical length a of the rectangular structure.

In the above-described optical unit structures, a viewing angle characteristics associated with a pair of the trapezoids 510 and 512 is better than a viewing angle characteristics associated with a pair of the triangles 520 and 522. Therefore, for example, the optical unit structures of the prism sheet may be formed such that a pair of the trapezoids 510 and 512 is arranged up and down for an apparatus that requires a better viewing angle toward up/down direction. Conversely, the optical unit structures of the prism sheet may be formed such that a pair of the trapezoids 510 and 512 is arranged left and right for an apparatus that requires a better viewing angle toward left/right direction.

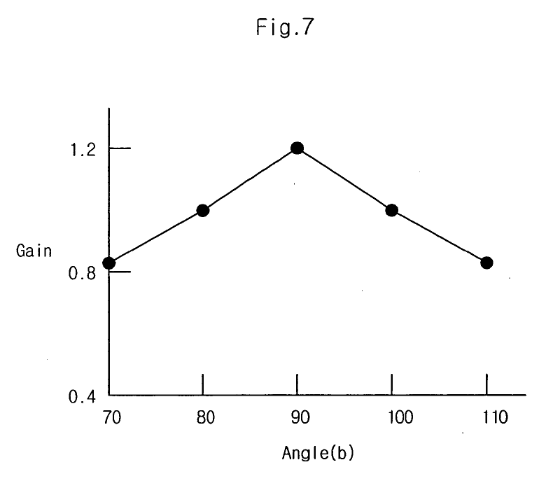

FIG. 6 is a graph illustrating relation between a viewing angle of the prism sheet according to the present invention and a length D of a central line of the optical unit structure explained with reference to FIG. 5.

Examination of the illustration of FIG. 6 reveals that a viewing angle is improved as the length D of the central line of the optical unit structure is increased.

However, if the length D is increased, a brightness is lowered inversely proportional to an improvement of a viewing angle. Accordingly, the length D may not exceed double the vertical length a of the rectangular structure as described above.

At this point, the vertical length of the rectangular structure is longer than at least about 10 μm.

Further, by maintaining constant an angle formed by a plurality of polyhedrons constituting each of the optical unit structures and a horizontal plane, it is possible to minimize a brightness deterioration due to an enlargement of a viewing angle.

Referring to FIGS. 4, 5 and 7, an angle formed by the plurality of polyhedrons constituting the optical unit structure and a horizontal plane is represented by b. Here, an angle formed by an incline plane of each polyhedron and a horizontal plane may be determined within a range of about 30-60°.

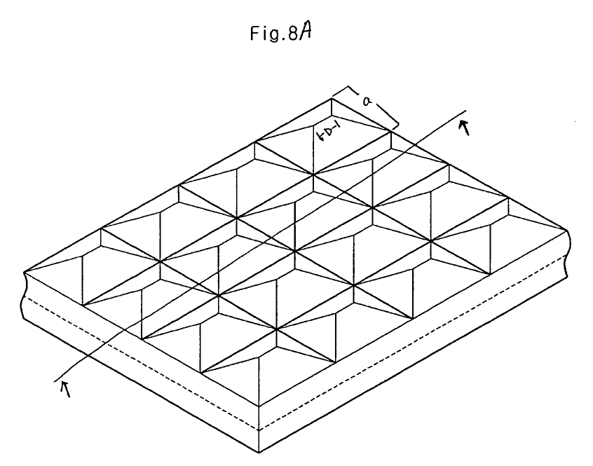

FIG. 7 is a graph illustrating relation between an angle b formed by a horizontal plane and a plurality of polyhedrons in the optical unit structure explained with reference to FIGS. 4 and 5 and a light-concentration degree of the prism sheet according to the present invention.

Referring to FIG. 7, a light-concentration degree is maximum when the angle b formed by a horizontal plane and a plurality of polyhedrons in the optical unit structure is 45°. As described above, an angle formed by an incline plane: of each polyhedron and a horizontal plane may be determined within a range of about 30-60°.

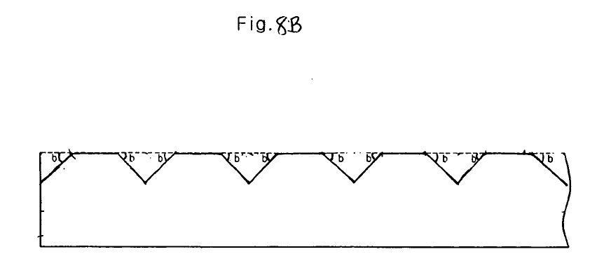

FIG. 8A is a perspective view of a prism sheet according to another embodiment of the present invention. FIG. 8B is a cross-sectional view of the embodiment illustrated in FIG. 8A.

Referring to FIG. 8A, in a prism sheet according to another embodiment of the present invention, an optical unit structure formed on a body part is formed in a relief (raised), not a intaglio (depression), compared with the prism sheet explained earlier. At this point, the plurality of optical unit structures arranged on the prism sheet is configured such that an relief-type polyhedron is formed in an inside of a rectangular structure and a center of the relief portion forms a line, not a dot. In this relief-type embodiment, the a pair of the trapezoids meet each other such that the optical unit structure has a line-type raised center. That is, the D-length side of the trapezoids is shared and is raised with respect to the longer sides of the trapezoids. In addition, the vertices of the triangles abut opposite ends of the D-length side of the trapezoids, and those vertices are raised with respect to the a-length sides of the rectangle.

At this point, since The prism sheet of the present invention can obtain a proper light-concentrating degree and an improved viewing angle by adjusting the raised center, i.e., a length D of a line formed at the central portion of the relief.

Here, the length D of the line formed at the central portion of the relief may not exceed double the vertical length a of the rectangular structure.

As described above, according to the present invention, a plurality of intaglio-type optical unit structures is arranged on one side of a prism sheet and the intaglio-type optical unit structures constitute a polyhedron, whereby an excellent light-concentrating effect can be obtained and a viewing angle is improved even more.

Further, a viewing angle characteristics for both up/down and left/right directions can be improved using a plurality of polyhedrons constituting the optical unit structures.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A prism sheet of a liquid crystal display, comprising:
a body part made of a transparent resin material; and
a plurality of intaglio-type optical unit structures arranged on the body part, each of the optical unit structures having an intaglio-type polyhedron in an inside of a rectangular structure thereof, a center of the intaglio portion forming a line.

2. The prism sheet according to claim 1, wherein the intaglio-type polyhedron is configured such that a pair of trapezoids and a pair of triangles face each other, respectively, forming four planes, such that pair of the trapezoids meet each other to form the line.

3. The prism sheet according to claim 2, wherein the line is formed along a short parallel side of each of the trapezoids.

4. The prism sheet according to claim 1, wherein the transparent resin material constituting the body part is one of PET (polyethyleneterephthalate) and PC (Polycarbonate).

5. The prism sheet according to claim 1, wherein the optical unit structures include PMMA (Polymethylmethacrylate).

6. The prism sheet according to claim 1, wherein small-sized protuberances as structures for diffusing light are embossed on a surface of the body part, opposite to a surface where the optical unit structures are formed.

7. The prism sheet according to claim 1, wherein grains made of PMMA (polymethylmethacrylate) as materials for diffusing light are included in an inside of the body part.

8. The prism sheet according to claim 1, wherein the plurality of intaglio-type optical unit structures is formed in the following way, in which: liquid PMMA (polymethylmethacrylate) material is made into a intaglio through a relief mold and formed on the body part and then hardened by an ultraviolet hardening method to be finally combined with the body part.

9. The prism sheet according to claim 1, wherein the optical unit structure is configured such that an intaglio-type polyhedron is formed in an inside of a rectangular structure whose length is on one side, the intaglio-type polyhedron having a pair of trapezoids and a pair of triangles facing each other, respectively, to form four planes, the pair of trapezoids meeting each other, thereby forming a line-type intaglio center having a predetermined length D.

10. The prism sheet according to claim 1, wherein an angle b formed by the plurality of polyhedrons constituting each optical unit structure and a horizontal plane is maintained constant within a range of about 30-60°.

11. The prism sheet according to claim 9, wherein the length D of the line formed at a center of the intaglio does not exceed double the length a of one side of the rectangular structure.

12. The prism sheet according to claim 9, wherein the length a of one side of the rectangular structure is longer than at least about 10 μm.

13. The prism sheet according to claim 10, wherein the angle b formed by the plurality of polyhedrons constituting each optical unit structure and a horizontal plane is 45°.

14. A prism sheet of a liquid crystal display, comprising:
a body part made of a transparent resin material; and
a plurality of relief-type optical unit structures arranged on the body part, each of the optical unit structures having a relief-type polyhedron in an outside of a rectangular structure thereof, a center of the relief portion forming a line.

15. A back light unit of a liquid crystal display, comprising:
a lamp for generating light;
a light guide plate arranged adjacent to the lamp for guiding the light;
a reflection plate arranged on a lower part of the light guide plate for preventing the light emitted from the lamp from leaking out;
a diffusion sheet and a prism sheet arranged on an upper part of the light guide plate, for improving efficiency of the light emitted from the light guide plate, the prism sheet having:
a body part made of a transparent resin material; and
a plurality of intaglio-type optical unit structures arranged on the body part, each of the optical unit structures having an intaglio-type polyhedron in an inside of a rectangular structure thereof, a center of the intaglio portion forming a line.
